(19) United States
(12) Patent Application Publication
(10) Pub. No.: US 2023/0316063 A1
(43) Pub. Date: Oct. 5, 2023

(54) NEURAL NETWORK PROCESSING

(71) Applicant: Arm Limited, Cambridge (GB)

(72) Inventors: Rachel Jean Trimble, Grindleford (GB); Sharjeel Saeed, Cambridge (GB); Daren Croxford, Swaffham Prior (GB)

(73) Assignee: Arm Limited, Cambridge (GB)

(21) Appl. No.: 17/708,474

(22) Filed: Mar. 30, 2022

(51) Int. Cl. G06N 3/08; G06N 3/04; G06K 9/62

(52) U.S. Cl. CPC G06N 3/08; G06N 3/04; G06K 9/6201

(57) ABSTRACT

An input data array is subjected to neural network processing to generate a result of the neural network processing for the input data array. A perturbation is applied to a part (but not all of) the input data array, with neural network processing then performed using the so-perturbed version of the input data array. However only some (and not all) of the perturbed version is subjected to neural network processing, based on the part of the input data array to which the perturbation has been applied. The result of the neural network processing of the perturbed version of the input data array is compared with the result of the neural network processing of the input data array without the perturbation, to determine whether the perturbation of the input data array has an effect on the result of the neural network processing.

### BACKGROUND

The technology described herein relates to the execution of neural networks in electronic devices.

Neural networks can be used for processes such as machine learning, computer vision and natural language processing operations.

Neural network processing generally comprises a sequence of operations (which may be referred to as “layers” of the neural network processing), which each process an input data array to provide an output data array (which may become the input data array for another operation (layer)). The sequence of operations (layers) may, for example, be able to process complex data (e.g. image, medical record/examination/test or sound data) to ultimately provide a desired output (e.g. identification of an object within an image, or a spoken word within a sound clip, or a medical diagnosis, or other useful output inferred from the input data). This process is usually known as “inferencing” or “classification”.

Because of the nature of neural network processing, it may not readily be apparent why a neural network produces a particular result from a given input, or how a neural network arrives at a given result from a given input.

However, it is becoming increasingly desirable to be able to explain how a neural network is arriving at its outputs, e.g. predictions, for example, to be able to provide confidence and trust in the neural network operation and that the neural network is making reasonable predictions in general. This may be particularly desirable for certain neural network applications, such as process control, automotive applications, or medical diagnostics, etc. In such cases, it would be desirable to be able to understand how a neural network is arriving at a particular medical diagnosis, for example, so as to, for example, have confidence that the neural network is arriving at the diagnosis based on the appropriate parameters.

It may also be particularly desirable to explain how a neural network is arriving at its outputs (and therefore to better understand the “decision” made), in the case where the output result is known to be incorrect or unexpected, so as to, for example, try to understand what particular attributes of the input data have led the neural network to arrive at its outputs.

However, it may not be readily determinable from a neural network itself how the neural network is operating to arrive at a particular result from given input data. There is therefore a desire for techniques to provide an “explanation” of the operation of neural networks.

One such technique that has been proposed for providing an explanation of the operation of neural networks is to perturb (modify) a subset of the inputs to the neural network to determine whether that changes the result from the neural network when processing the perturbed (modified) input to the neural network (as compared to the result that was produced without the perturbations in the input). This can help to provide an understanding of which parts of the input are important to the output result (in that if the perturbed input changes the result, then it can be assumed that the subset of the input that was perturbed is significant to the output result (and vice-versa)). “LIME” (local interpretable model-agnostic explanations) is an example of one such perturbation-based algorithm.

Perturbation-based techniques such as LIME processing can provide a mechanism for understanding which parts of an input data set are important to a neural network. However, the Applicants believe that there remains scope for more efficient performing of perturbation-based processing when attempting to derive an “explanation” of the operation of a neural network.

### BRIEF DESCRIPTION OF THE DRAWINGS

A number of embodiments of the technology described herein will now be described by way of example only and with reference to the accompanying drawings, in which:

FIG. 1 shows schematically a data processing system which may be configured to perform neural network processing in the manner of the technology described herein;

FIG. 2 shows an input data array and a perturbed version of the same;

FIG. 3A shows schematically the neural network processing of the unperturbed version of the input data array in an embodiment of the technology described herein;

FIG. 3B shows schematically the neural network processing of a perturbed version of an input data array in an embodiment of the technology described herein;

FIG. 4 shows schematically the neural network processing of a perturbed version of an input data array in another embodiment of the technology described herein;

FIG. 5 shows schematically the neural network processing of a perturbed version of an input data array in another embodiment of the technology described herein;

FIG. 6 shows schematically the neural network processing of two similarly-perturbed versions of an input data array in another embodiment of the technology described herein;

FIG. 7 is a flow diagram of the neural network processing for unperturbed and perturbed versions of an input data array in an embodiment of the technology described herein; and

FIG. 8 shows an input data array and perturbed version of the same in an embodiment of the technology described herein.

### DETAILED DESCRIPTION

A first embodiment of the technology described herein comprises a method of performing neural network processing in a data processing system, the data processing system comprising a processor operable to execute a neural network, and operable to store data relating to the neural network processing being performed by the processor to memory, the method comprising:
for an input data array to be processed by a neural network, subjecting the input data array to neural network processing to generate a result of the neural network processing for the input data array; and
applying a perturbation to a part but not all of the input data array, and performing the neural network processing using the so-perturbed version of the input data array to generate a result of the neural network processing for the perturbed version of the input data array;
wherein
performing the neural network processing using the perturbed version of the input data array comprises:
   subjecting only some but not all of the perturbed version of the input data array to neural network processing when performing the neural network processing using the perturbed version of the input data array, based on the part of the input data array to which the perturbation has been applied; and
   comparing the result of the neural network processing of the perturbed version of the input data array with the result of the neural network processing of the input data array without the perturbation, to determine whether the perturbation of the input data array has an effect on the result of the neural network processing.

A second embodiment of the technology described herein comprises a data processing system, the data processing system comprising:
a processor operable to execute a neural network and operable to store data relating to the neural network processing being performed by the processor to memory;
the data processing system further comprising a processing circuit configured to cause the processor to:
subject an input data array to neural network processing to generate a result of the neural network processing for the input data array;
and to
subject a perturbed version of the input data array to the neural network processing to generate a result of the neural network processing for the perturbed version of the input data array, the perturbed version of the input data array comprising a version of the input data array in which a perturbation has been applied to a part but not all of the input data array;
wherein
performing the neural network processing for the perturbed version of the input data array comprises:
   subjecting only some but not all of the perturbed version of the input data array to neural network processing when performing the neural network processing for the perturbed version of the input data array, based on the part of the input data array to which the perturbation has been applied; the data processing system further comprising:
   a processing circuit configured to compare the result of the neural network processing of the perturbed version of the input data array with the result of the neural network processing of the input data array without the perturbation, to determine whether the perturbation of the input data array has an effect on the result of the neural network processing.

The technology described herein relates to neural network processing, and in particular to neural network processing in which a perturbation is applied to an input data array that has been subjected to neural network processing to determine whether the perturbation affects the result of the neural network processing (e.g. as in, and in an embodiment in accordance with, “LIME” processing as discussed above).

Thus in the technology described herein, an input data array is subjected to neural network processing, and then a part of that input data array is perturbed and the so-perturbed version of the input data array is then subjected to the neural network processing again, to determine whether the perturbation changes the result of the neural network processing. This can then, as discussed above, give an indication of whether the part of the input data array that was perturbed has significance for the result of the neural network processing.

However, in the technology described herein, rather than simply subjecting the entirety of the perturbed version of the input data array to the neural network processing, only a part of the perturbed version of the input data array is subjected to (at least some of) the neural network processing.

The Applicants have recognised in this regard that, and as will be discussed in more detail below, when generating the result for the perturbed version of the input data array, it may only be necessary to process the part of the input data array to which the perturbation has been applied through some or all of the neural network to determine whether the perturbation has any effect on the result of the neural network processing, as, for example, neural network processing for the other, non-perturbed, parts of the input data array can either be omitted without affecting the overall result of the neural network processing, and/or a result or results from the neural network processing of the initial, non-perturbed, version of the input data array can be reused for a part or parts of the perturbed version of the input data array to which the perturbation is not applied, when generating the result of the neural network processing for the perturbed version of the input data array.

The technology described herein then exploits this by performing at least some of the neural network processing for the perturbed version of the input data array for only a part of the perturbed version of the input data array based on the part of the input data array to which the perturbation is applied.

In other words, when performing the neural network processing for the perturbed version of the input data array, some or all of the neural network processing for the perturbed version of the input data array is omitted (is not performed (is other than performed)), based on which part of the input data array the perturbation has been applied to.

This then reduces the overall amount of processing that is required to be done for the perturbed version of the input data array, thereby reducing the amount of processing that needs to be done for “explaining” the operation of the neural network, e.g. using a “LIME”-type mechanism.

The data processing system of the technology described herein may be any suitable data processing system that can execute a neural network and may comprise any suitable and desired components and elements that a data processing system can comprise, such as one or more or all of: a display processing unit, a central processing unit (CPU), a graphics processing unit (GPU) (graphics processor), a video processor, a signal processor, a display and a memory.

Correspondingly, the processor that executes the neural network may comprise any suitable processor that is capable of doing that, such as a central processing unit (CPU), a graphics processing unit (GPU) (graphics processor), a video processor, a sound processor, an image signal processor (ISP), a digital signal processor, and a Neural Network Accelerator/Processor (Neural Processor Unit) (NPU).

The data processing system is in an embodiment implemented on (as part of) an electronic device. Thus the technology described herein also extends to an electronic device that includes the data processing system of the technology described herein (and on which the data processing system operates in the manner of the technology described herein). The electronic device is in an embodiment a portable and/or lower powered device, such as a mobile phone or tablet.

The memory in which the data relating to the neural network processing is stored may comprise any suitable memory. The memory may be part of the data processing system, such as a main memory of the data processing system, or may be separate to the data processing system.

In an embodiment, the data processing system also includes further storage (memory) that is “local” to the processor, in which data can be stored for use by the processor when executing a neural network, rather than having to access data from the (main) memory. Hence, the data processing system may comprise both local (e.g. on-chip) and main (e.g. external) memory (e.g. comprising RAM, SRAM, DRAM, and/or SDRAM).

The technology described herein may be used in conjunction with any suitable and desired neural network. In embodiments, the neural network is a convolutional neural network.

The neural network in an embodiment comprises one or more, and in an embodiment a plurality, of layers, which operate in turn, e.g. such that the output data array provided for one layer becomes the input data array for a next layer. The layers of the neural network may, and in an embodiment do, comprise one or more convolutional layers, pooling layers and/or fully connected layers.

The input data array that is to be (partially) perturbed in accordance with the technology described herein may be any input data array that is processed within the neural network. In embodiments, the input data array that is (partially) perturbed comprises the initial input data array for the neural network (i.e. the initial set of data that is input into the first (input) layer of the neural network). However, it could, if desired, instead be an input data array (e.g. feature map) that is input into a different (e.g. intermediate) layer of the neural network (and that has been output by a previous layer of the neural network).

The initial input data array that is processed by the neural network (and that may be, as will be described below, in part perturbed according to the method of the technology described herein) may comprise any suitable input data array which can be processed by a neural network to produce a useful output. For instance the initial input data array may comprise an image, an image from an Image Signal Processor (ISP), an image frame from video data, sound data or voice data, or other input data. Correspondingly the neural network may be operable to identify or classify features present within the input data array, e.g. such as objects in an input image, or sound features in input sound data.

The input data array that is being perturbed may comprise any suitable number of (data) channels. For example, in the case where the initial input data for the neural network comprises an image, the image may comprise a grayscale image, and thus have one (single) channel. In embodiments, the initial input data array being (partially) perturbed is an, e.g. 8-bit per channel, R, G, B image (i.e. comprising three channels). In the case wherein the initial input array being perturbed comprises sound or voice data, that data in an embodiment comprises a single (e.g. 16 bit) channel.

In the technology described herein, a part (but not all) of the input data array is perturbed, thereby resulting in a perturbed version of the input data array that is made up of the perturbed part of the input data array (i.e. the part that differs from the original input data array) and a non-perturbed part of the input data array (i.e. a part that is the same as the original input data array).

The perturbation that is to be applied to (some but not all of) the input data array may be of any suitable or desired form.

As will be understood, the perturbation that is applied to some of the input data array will involve applying some sort of operation to the data values of a subset of the data elements that make up (the entirety of) the input data array, thereby modifying those values. For example, in the case wherein the input data array being perturbed comprises image data, the perturbation may be (and in an embodiment is) in the form of a modification to one or (and in an embodiment) more pixel values of the image data.

The subset of data elements of the input data array to which the perturbation is applied may be chosen in any suitable or desired manner. For example, the perturbation could be applied to only a single data element of the input data array. However, in embodiments, the perturbation is applied to a plurality of data elements in the input data array.

In embodiments, the perturbation is applied to a plurality of adjacent data elements of the input data array, i.e. such that the perturbation is applied to each data element in a particular “region” of the input data array. For example, in the case wherein the input data array comprises an image, the perturbation may be applied to each pixel of a group of pixels (data elements) in a particular area (region) of the image (such as, e.g. a square area, e.g. a grid of 4×4 or 8×8 pixels within the array of pixels that make up the entire image). The perturbation could (and in other embodiments is) be applied to multiple such pluralities of data elements, i.e. such that the perturbation is applied to each data elements in multiple particular (e.g. non-adjacent) “regions” of the input data array.

The perturbation could (and in some embodiments is) be applied to a subset of data elements of the input data array that are not (all) adjacent. For example, the perturbation could be applied to a subset of data elements of the input data array that are randomly chosen from the set of data elements that make up the entirety of the input data array. Other arrangements are, of course, possible.

In the case wherein the input data array comprises more than one channel, the perturbation may be applied to data elements in one or more of the channels. In the case where the input data array which is being (partially) perturbed comprises an 8-bit per channel R, G, B image (i.e. comprising 3 channels), data values across one, two, or (and in an embodiment) all three channels are perturbed. For example, the perturbation may be applied to (each of) the R, G and B values of pixel(s) of the image.

The operation that is applied to the data element(s) (that are being perturbed) as part of the perturbation, in order to modify their values, may be any suitable or desired operation, and may be chosen, e.g., in accordance with the type of data that is being perturbed.

In some embodiments, the perturbation may include setting the values of the data element(s) of the input data array (which are being perturbed) to a new (e.g. predefined) value. For example, the perturbation may comprise “zeroing” the data values of the data element(s), by setting their data values to 0. Alternatively, the perturbation may comprise adding or subtracting an amount (value) from each of the data value(s) of the data element(s) to which the perturbation is applied. In cases wherein the input data array comprises image data, the perturbation may comprise modifying a group or groups of pixels (data elements) in such a way as to blur those pixels.

In some embodiments, the perturbation may be such that each and every one of the subset of data elements of the input data array that are being perturbed are modified in a same manner (e.g. by “zeroing” the values of all of the data elements in the subset of data elements that are being perturbed). However the perturbation could, instead, comprise modifying different data elements of the subset differently (e.g. by setting their data values to different values, or by adding or subtracting a different value, etc.). For example, the perturbation could include adding or subtracting a different randomly generated value to different data elements of the input data array, thereby adding “noise” to the data.

Other types of perturbations are, of course, possible.

The perturbation can be applied to the original (unperturbed) input data array (in order to generate the perturbed version of the input data array) in any suitable or desired manner.

For example, and in cases wherein the (unperturbed) input data array is stored in memory (e.g. local or main memory), the perturbed version of the input data array may be generated by applying the perturbation directly to the stored input data array (by modifying the data values of a subset of the data elements of the input data array, in the manner described above), thus overwriting the unperturbed version of the input data array with the perturbed version of the input data array.

However, in embodiments, e.g. where it is desired to not overwrite the original unperturbed version of the input data array (e.g. so that the original, unperturbed version of the input data array remains stored in memory), the perturbed version of the input data array is generated by first copying the (entirety of the) (unperturbed) input data to another location in (e.g. local or main) memory, and then applying the perturbation to the copied version of the input data array (by modifying the data values of a subset of the data elements of the (copied) input data array, in the manner described above).

However, the Applicants have recognised that, since only a portion (and not all) of the input data array is being perturbed and subjected to processing neural network processing, it may not be necessary to copy the entirety of the (unperturbed) input data array to prior to applying the perturbation, but, rather, only a portion of the input data array that includes (or is limited to) the particular part of the input data array to which a perturbation is being applied.

Thus, in an embodiment, the technology described herein comprises, when generating the so-perturbed version of the input data array, copying a part of the input data array to memory, and then applying the perturbation to that part of the input data array, and wherein the some but not all of the perturbed version of the input data array that is subjected to neural network processing comprises that copied and perturbed part of the input data array.

In the technology described herein, neural network processing is performed in respect of only some of the perturbed version of the input data array, with the result of that processing being compared to the result of the neural network processing of the unperturbed input data array, in order to determine whether the perturbation changes the result of the neural network processing.

The part of the perturbed version of the input data array that neural network processing is performed in respect of should therefore include (or, e.g. be limited to) at least some of (and in an embodiment all of) the subset of data elements that were perturbed. For example, neural network processing may be performed in respect of a particular region of the perturbed input data array that includes the perturbed (modified) data elements, but not performed in respect of other regions of the perturbed input data array which do not include any perturbed (modified) data elements (and thus are identical to the corresponding regions of the original, unperturbed array of data elements).

In some embodiments, the part of the perturbed version of the input data array that neural network processing is performed in respect of directly corresponds to the part of the input data array that was perturbed. In other words, it is limited to only the subset of data elements that were perturbed. In other embodiments, the part of the perturbed version of the input data array that neural network processing is performed in respect of is larger than the part of the input data array that was perturbed, i.e. it includes both the perturbed subset of data elements and unperturbed data elements.

The particular part of the perturbed version of the input data array that neural network processing is to be performed in respect of should be chosen such that a meaningful result can be generated from the neural network processing. This will depend on the type and structure of the neural network (including, e.g., the type of layers that the neural network comprises) and the points within the network (if any) at which output data has been stored when performing the neural network processing in respect of the original (unperturbed) version of the input data array (as will be discussed further below).

As will be understood, in regular neural network processing, an (entire) input data array for a particular layer of the neural network is input and processed by that layer, thereby generating an output comprising an output data array, which may then be used as an input data array to be input for the next layer of the neural network, etc. and so on, until a final output (i.e. an output of the final processing layer of the neural network) is produced.

In the technology described herein, when performing neural network processing in respect of the (partial) perturbed version of the input data array, the layer of the neural network that receives the perturbed input data array processes only a part of that perturbed input data array, and thus generates an output which, accordingly, comprises only a part of a (full) output data array (based on the part of the perturbed input data array that it receives). As will be understood, the size of the (partial) output array generated by this layer may depend on the size of the part of the perturbed input array that was processed by the layer.

This means that the next layer of the neural network will only have part of an input data array available for processing, on the basis of the previous layer's processing of the (partial) perturbed version of the input data array.

At this stage, whether or not processing for this next layer will be able to continue in respect of the (partial) output array that was generated by the previous layer alone will depend on the size of that (partial) output array that was generated by the previous layer, the structure of the neural network and, in particular, the type of layer in question.

For example, for some layers of some neural networks, e.g. some pooling or convolutional layers, it may be possible for the layer to generate a meaningful (partial) output based on (only) the (partial) output that was generated by the previous layer alone (so long as that partial output is large enough). Thus in this case, this next layer may process the (partial) data array generated and output by the previous layer, to generate and output another (partial) data array for use as an input for the subsequent layer.

In a neural network comprising, e.g., only convolutional and pooling layers (and, e.g., without fully connected layers, such as, e.g., a convolutional neural network for performing image enhancement), this process may then be able continue throughout the entire remainder of the neural network (i.e. through each and every remaining layer of the neural network), until a final (partial) output (result) is generated (by the final layer) based on the neural network processing of the perturbed version of the input data array. (This final output may then be compared with the final output generated by processing the original (unperturbed) input data array, to determine whether the perturbation of the initial data array affected the result of the neural network processing.)

However, the Applicants have recognised that some layers in some neural networks, such as, e.g. fully connected layers, may not be able to generate a meaningful output (e.g. for use in subsequent layers) on the basis of a particular (partial) data array received from the previous layer (that has been generated in respect of the perturbed data array) alone. In other words, in order to generate a meaningful output, the layer will require not only the (partial) output array received from the previous layer, but will also require additional inputs, i.e. the “missing” values that were not generated by the previous layer when producing the partial output.

The Applicants have recognised in this regard however that, in this situation, it would still be possible to perform processing for those layers when performing neural network processing for the perturbed version of the input data array, by having the layer use, in place of the “missing” output values, the corresponding output values that were generated when processing the previous layer for the original (unperturbed) version of the input data array. The Applicants have recognised that this substitution can be facilitated by, when performing neural network processing for the original (unperturbed) input data array, storing those values to memory, such that they can be read back and substituted in at the necessary time when performing neural network processing for the perturbed version of the input data array.

Hence, in an embodiment, the technology described herein includes storing some or all of the output of the neural network processing for a layer or layers of the neural network processing when processing the (original unperturbed) input data array, and reusing the output of the neural network processing for a layer or layers of the neural network processing stored from the processing of the input data array when performing the neural network processing for the perturbed version of the input data array.

Outputs may be stored for one layer, or multiple layers, of the neural network. In an embodiment, the output that is stored for a layer of the neural network processing when processing the (original unperturbed) input data array is re-used when processing (and as part of an input for) the next layer of the neural network processing when performing the neural network processing for the perturbed version of the input data array. In an embodiment, only outputs are stored that will be known to be required or likely to be required when processing the perturbed version of the input data array (such as, e.g., and as described above, those output values that are generated by layers preceding a fully connected layer, and that will therefore likely be required when processing the fully connected layer).

Hence, in an embodiment, the technology described herein includes reusing the output of the neural network processing for a layer or layers of the neural network processing stored from the processing of the (original unperturbed) input data array when processing (and as part of an input for) a fully connected layer or layers when performing neural network processing for the perturbed version of the input data array.

As discussed above, in some neural networks, certain layers other than fully connected layers (e.g. some convolutional, pooling layers) of the neural network may be able to generate a meaningful output based on the (partial) output array received from the previous layer alone (i.e. without using stored output values from the processing of the unperturbed data array) so long as that partial output array generated by the previous layer is large enough.

As will be understood, the size of that partial output array generated by the previous layer may be dependent on the size of the original part of the perturbed input data array for which neural network is being performed in respect of (i.e. such that performing neural network processing in respect of a larger part of the perturbed input array will result in larger (partial) output arrays within the network). Thus for these particular certain layers of the neural network, there may be a minimum size of (partial) output array from the previous layer (and, hence, a minimum size of the original part of the perturbed input data array for which neural network is being performed) that will be necessary in order for the layer to be able to generate a meaningful output based on that (partial) output array from the previous layer alone.

The Applicants have recognised however that, for these layers, rather than necessarily having to perform processing in respect of a larger part of the perturbed input array in order for the output generated by the previous layer to be of that minimum size, it may be possible to instead perform processing in respect of a smaller part of the perturbed input array, but then use stored values from the neural network processing of the unperturbed input data array in place of the “missing” inputs for those layers when performing neural network processing for the perturbed version of the input data array, in the manner described above. Processing a smaller part of the perturbed data array and substituting stored values from the stored output of the neural network processing of the unperturbed input data array in this manner may lead to reduced processing costs, compared to processing the larger part of the perturbed input data array.

Therefore the Applicants have recognised that it can also be beneficial to re-use an output of the neural network processing for the layer or layers of the neural network processing stored from the processing of the (unperturbed) input data array when processing a non-fully connected layer of the neural network when performing neural network processing for the perturbed version of the input data array.

Hence, in an embodiment, the technology described herein includes reusing the output of the neural network processing for a layer or layers of the neural network processing stored from the processing of the (original unperturbed) input data array when processing (and as part of an input for) a convolutional or pooling or other non-fully connected layer or layers when processing the perturbed version of the input data array.

It should be understood that the choice of layer(s) for which to store output values within the neural network may affect the size of the part of the perturbed input array for which neural network processing needs to be performed. This may lead to a trade-off between the number of layers that may be partially processed without requiring stored values to be substituted in, and the size of the part of the perturbed input data array that is being processed.

For example, choosing to storing outputs for layer(s) further down the neural network may mean that more layers can be partially processed before reaching the point in the network wherein stored values are required to be substituted in, but this may in turn require a larger part of the perturbed input data array to be subjected to neural network processing. Conversely, storing output for layer(s) earlier in the network can reduce the size of the part of the perturbed input data array for which neural networking processing will need to be performed, but this will also reduce the number of layers that can be processed before those stored values will need to be substituted in in order for neural network processing to continue.

The storing of the output of the layer or layers when processing the (original, unperturbed) input data array can be carried out in any suitable and desired manner. In some embodiments, the output(s) are stored in local storage (memory), such that they can be more easily retrieved when performing neural network processing for the perturbed version of the input data array. The output(s) may be stored in uncompressed or compressed formats, as desired.

The output of a layer or layers of the neural network that are stored may comprise the entire output data array that is generated by the layer or layers when processing the original (unperturbed) input data array. This may be the case in embodiments wherein, e.g., it is not known at the time that the output is stored what part of the input data array is going to be perturbed (and, hence, what particular part of the output generated when processing the layer or layers for the original (unperturbed) data will be needed for processing the next layer or layers for the perturbed version of the input data array).

However, in some embodiments, for example where it is known what part of the input data array is or is going to be perturbed (and hence it is also known which values of the output data array generated when processing the layer or layers for the original (unperturbed) data will be needed for processing the next layer or layers for the perturbed version of the input data array) rather than store the entire output data array that is generated by the layer or layers when processing the original (unperturbed) input data array, the output that is stored comprises only a subset of values (or covers only a portion) of the output data array that is generated by the layer or layers when processing the original (unperturbed) input data array. For example, the output that is stored may only comprise only those values (i.e. cover only the portion) of the output data array that will be required for the next layer of the neural network to generate a meaningful output when performing neural network processing in respect of the perturbed input data array. (For example, the output may not be stored for portions of the output array where it is known that the corresponding portion generated when processing the perturbed version of the input data array will be used instead.)

In the technology described herein, a result of the neural network processing of the perturbed version of the input data array is compared to a result of neural network processing of the unperturbed input data array. This comparison allows a determination as to whether the perturbation of the input data array has an effect on the result of the neural network processing.

In some embodiments, when subjecting the original (unperturbed) version of the input data array to neural network processing, the original (unperturbed) input data array is processed through all of the layers of the neural network, i.e. such that a final output result (i.e. a final output of the final processing layer of the neural network) is generated for the (original unperturbed) input data array, and then, similarly, when subjecting the perturbed version of the input data array to neural network processing, the perturbed version of the input data array is processed through all of the layers of the neural network, i.e. such that a final output result (i.e. a final output of the final processing layer of the neural network) is generated for the perturbed version of the input data array. The final output result for the original (unperturbed) data array is then compared to the final result of the perturbed version of the output data array. If the two final output results are determined to match (or to be sufficiently similar), then it may be reasonably assumed on the basis of the comparison that the perturbation does not have a (meaningful) effect on the result of the neural network processing. (This comparison could be made by comparing the “raw” values of the two final output results generated by the final layer of the neural network, or, and as discussed further below, by comparing information representative of those two outputs.)

However, the Applicants have recognised in this regard that it may be evident from outputs of intermediate layers within the neural network that are generated during the neural network processing whether or not the perturbation will have an effect on the final output results. For example, if the output for a particular (intermediate) layer generated when performing the neural network processing of the original unperturbed input data array matches (or is sufficiently similar to) the output for the same particular (intermediate) layer generated when performing the neural network processing of the perturbed version of the input data array, then this could be taken to mean that the final output result that would be generated for perturbed version of the input data array will be the same (or sufficiently similar) to the final output result generated for the original (unperturbed) version of the input data array.

The Applicants have further recognised that a comparison of these outputs from intermediate layers could be facilitated by storing the output when performing neural network processing for the original (unperturbed) input data array, and then retrieving the stored output so that it can be compared to the corresponding output from the corresponding layer when performing neural network processing for the perturbed version of the input data array.

Thus, the Applicants have recognised that, in this case, it would not be necessary to continue processing through the remaining layers of the neural network for the perturbed version of the input data array, since it can already be known that the perturbation has no meaningful effect on the final output result that is generated. The neural network processing of the perturbed version of the input data array may therefore be terminated at this stage (i.e. without processing the remaining layers), thereby saving processing power expended and reducing the processing time taken to determine that the perturbation does not result in any meaningful effect.

On the other hand, in the event that the output for the particular (intermediate) layer generated when performing the neural network processing of the original unperturbed input data array does not match (or is not sufficiently similar to) the output for the same particular (intermediate) layer generated when performing the neural network processing of the perturbed version of the input data array, then, e.g., depending on the structure of the neural network, that in itself may not necessarily mean that the final output results for the unperturbed and perturbed input data arrays ultimately will not match (or be sufficiently similar) (such that it can be (safely) determined at that point that the results will match (or be sufficiently similar). Thus, in this case, neural network processing in respect of the perturbed version of in the input data array should be, and in an embodiment is, continued (by processing the next, and e.g. subsequent, layer(s) of the neural network).

Hence, in an embodiment, the method of the technology described herein comprises (and the data processing system is correspondingly configured to) storing the output of the neural network processing for a layer or layers of the neural network processing when processing the input data array; and
comparing the output for a layer of the neural network processing when processing the perturbed version of the input data array to the stored result of the processing of that layer when processing the input data array; and
determining whether to continue the neural network processing for a part or parts of the perturbed version of the input data array on the basis of the comparison.

The Applicants have further recognised that storing and comparing outputs of (intermediate) layers when performing neural network processing for unperturbed and perturbed versions of an input data array in the manner described above may also be beneficial in other, e.g. more general perturbation-based neural network methods and data processing systems, e.g. wherein neural network processing may be performed in respect of a whole perturbed version of an input data array (rather than only some but not all of a perturbed version of an input data array, in the manner described above).

Thus, another embodiment of the technology described herein comprises a method of performing neural network processing in a data processing system, the data processing system comprising a processor operable to execute a neural network, and operable to store data relating to the neural network processing being performed by the processor to memory, the method comprising:
for an input data array to be processed by a neural network, performing neural network processing using the input data array to generate a result of the neural network processing for the input data array, the performing neural network processing using the input data array comprising storing an output of the neural network processing for a layer or layers of the neural network processing when processing the input data array; and
applying a perturbation to a part but not all of the input data array, and performing neural network processing using the so-perturbed version of the input data array to generate a result of the neural network processing for the perturbed version of the input data array;
wherein performing the neural network processing for the perturbed version of the input data array comprises:
   comparing an output for a layer of the neural network processing when processing the perturbed version of the input data array to the stored result of the processing of that layer when processing the input data array without the perturbation; and
   determining whether to continue the neural network processing for a part or parts of the perturbed version of the input data array on the basis of the comparison.

Another embodiment of the technology described herein comprises a data processing system, the data processing system comprising:
a processor operable to execute a neural network; and operable to store data relating to the neural network processing being performed by the processor to memory;
the data processing system further comprising a processing circuit configured to cause the processor to:
subject an input data array to neural network processing to generate a result of the neural network processing for the input data array, wherein performing the neural network processing using the input data array comprises storing an output of the neural network processing for a layer or layers of the neural network processing when processing the input data array;
and to
subject a perturbed version of the input data array to the neural network processing to generate a result of the neural network processing for the perturbed version of the input data array, the perturbed version of the input data array comprising a version of the input data array in which a perturbation has been applied to a part but not all of the input data array;
the data processing system further comprising:
   a processing circuit configured to compare an output for a layer of the neural network processing when processing the perturbed version of the input data array to the stored result of the processing of that layer when processing the input data array without the perturbation, to determine whether to continue the neural network processing for a part or parts of the perturbed version of the input data array on the basis of the comparison.

As will be appreciated by those skilled in the art, these embodiments of the technology described herein can, and in embodiments do, include any one or more or all of the features of the technology described herein, as appropriate.

The storing of the output for a layer output of the neural network processing for a layer or layers of the neural network processing when processing the (unperturbed) input data array may be carried out in any suitable or desired manner In some embodiments, the output(s) are stored in local storage (memory), such that they can be more easily retrieved when performing neural network processing for the perturbed version of the input data array.

The layer or layers for which an output is stored when processing the original (unperturbed) data array may be chosen as desired.

In this regard, the Applicants have recognised that it may be particularly beneficial to store (for later comparison) outputs of pooling layers of the neural network, particularly max pooling layers. Storing outputs (for later comparison) for these layers (e.g. in preference to other layers) may be particularly beneficial, since the output data arrays of pooling layers will often have a reduced size and/or dimensionality compared to the output data arrays of other layers, which means that the size of the output to be stored may be comparatively smaller compared to the outputs of other layers, and comparisons between the stored output for the original (unperturbed) input data array and the output for the perturbed input data array may be carried out more efficiently.

Further, the Applicants have found that the output data arrays of pooling layers for unperturbed and perturbed input data arrays are often more likely to be the same (or sufficiently similar) in the case wherein the perturbation does not affect the final output result of the neural network processing, compared to the outputs of other, earlier layers of the neural network. In other words, the similarity of outputs of pooling layers for the unperturbed and perturbed input may be more indicative of the similarity of the overall output results for the unperturbed and perturbed input data arrays, compared to outputs of other (e.g. earlier) layers of the neural network. For example, for a 2×2 max pooling layer, only one of the four generated values from the previous layer (the maximum value) will be output. If the perturbation of the perturbed version of the input array only affects the values that are not used, then the output of this layer will match the output generated when processing the unperturbed version of the input data array (and hence it can be determined that the perturbation does not affect the final output result of the neural network processing).

Hence, in an embodiment, the layer or layers for which the output is stored when the processing the (unperturbed) input data array comprises a pooling layer, and the output for that pooling layer when processing the perturbed version of the input data array is compared to the stored result of the processing of that pooling layer when processing the (unperturbed) input data array.

The output of the neural network processing for a layer or layers that is stored when processing the (unperturbed) input data array may comprise any suitable or desired output.

In some embodiments, the output of the neural network processing for a layer or layers that is stored when processing the (unperturbed) input data array comprises the actual output data array (or a portion or portions thereof) (i.e. comprising the data values of data elements that make up the output data array) that is generated by the layer or layers when processing the (unperturbed) input data array. In some of these embodiments, the output for a layer of the neural network when processing the perturbed version of the input data array is compared to the stored output generated by that layer when processing the (unperturbed) input data array by comparing data values of corresponding data elements for the two output data arrays.

However, in other embodiments, the output for a layer or layers that is stored comprises information representative of the output data array that is generated by the layer or layers when processing the (unperturbed) input data array. In other words, rather than storing the actual (raw) output data array itself (i.e. the individual data values for individual data elements of the output data array) that is generated by the layer or layers when processing the (unperturbed) input data array, information representative of one or more data elements of the output data array is in an embodiment generated and stored. In some of these embodiments, corresponding information representative of the content of the output data array that is generated by the layer or layers when processing the perturbed version of the input data array is also generated, such that the two sets of information representative of the two output data arrays can then be compared.

The Applicants have recognised in this regard that comparing information representative of the two output arrays that are generated by the layer in question makes the comparison more efficient compared to an, e.g. data element-by-data-element comparison. Further, storing and later retrieving (as part of the comparison process) information representative of the output data array (rather than. e.g. the data values of individual data elements of the output data array that is generated) may reduce the total amount of data that is written and retrieved from memory, thereby making the comparison process more power and bandwidth efficient.

Hence, in an embodiment of the technology described herein, the outputs of the respective layers of the neural network processing are compared by comparing information representative of the output data arrays generated by the respective layers.

The information representative of the output data arrays generated by the layer or layers can be any suitable and desired information that is representative of the output data arrays.

In an embodiment, the information representative of the output data arrays generated by the layer or layers comprises compression metadata. The compression metadata may comprise any suitable or desired form of compression metadata that is able to be generated from (based on) the output data array generated by the layer.

In another embodiment, the information representative of the output data array generated by a layer is in the form of one or more “signatures”, which signature(s) are generated from (based on) the content of the output data array generated by the layer. Such a content indicating “signature” may comprise, e.g., and in an embodiment, any suitable set of derived information that can be considered to be representative of the content of the output data array generated by the layer, such as a checksum, a CRC, or a hash value, etc., derived from (generated for) the output data array generated by the layer. Suitable signatures would include standard CRCs, such as CRC32, or other forms of signature such as MD5, SHA 1, etc. In some embodiments, plural signatures may be generated in respect of different regions of the output data array.

Thus a respective signature or signatures, such as the CRC or hash value, will be generated from the values for some or all of the data elements of the output data array generated by the layer for which the content representing signature is being generated. Correspondingly, the data processing system in an embodiment comprises a suitable “signature” generating circuit, such as a circuit that executes a CRC function or a hash function, to thereby generate a content indicating signature, for a respective set of input data values.

In some embodiments, the output of the neural network processing for layer that is stored when processing the (unperturbed) input data array corresponds to the entire output data array that is generated by that layer when processing the (unperturbed) input data array. For example, in embodiments wherein the output that is stored comprises individual data values of data elements of the generated output data array, that output may comprise the data value(s) of each and every data element of the output data array that is generated (thereby representing the entirety of the generated output data array). Similarly, in (alternative) embodiments wherein information representative of the output data array that is generated is stored, that information representative of the output data array that is generated may comprise information representative of the entire output data array.

However, in other embodiments, rather than store an output that corresponds to the entire output data array for the layer when processing the (unperturbed) input data array, the output that is stored corresponds to only a portion of the output data array that is generated for the layer. For example, in embodiments wherein the output that is stored comprises individual data values of data elements of the generated output data array, that output may comprise the data value(s) of a subset of the data elements of the output data array that is generated (thereby representing only a portion of the generated output data array). Similarly, in (alternative) embodiments wherein information representative of the output data array that is generated is stored, that information representative of the output data array that is generated may comprise information representative of only a portion of the output data array.

The Applicants have recognised that this may be particularly useful for a layer or layers of a neural network for which it is known that the output array generated when performing neural network processing for the perturbed version of the input data array will only be a (particular) partial output data array (e.g. as described above), i.e. comprising only a (particular) portion of an (entire) output data array that would ordinarily be generated by the layer of the neural network (e.g. when performing neural network processing for a full (rather than part of) an input data array). In this case, rather than store an output that corresponds to the entirety of the output data array generated for the layer when processing the (unperturbed) input data array, the Applicants have recognised that an output corresponding to (e.g. only) the portion of the output data array that corresponds to the particular partial output data array that will be generated when performing neural network processing for the perturbed version of the input data array needs to be stored, since in this case only those two particular portions of the respective output data arrays will need to be compared (in the manner described above). By storing an output for (e.g. only) the portion of the output data array corresponding to the portion that will be generated when performing neural network processing for the perturbed version of the input data array (such that the two outputs can be compared) the total amount of data that is written to memory may be reduced.

Hence, in another embodiment of the technology described herein, the output of the neural network processing for a layer of the neural network processing when processing the (unperturbed) input data array that is stored corresponds to only a portion of an output data array that is generated for that layer when processing the (unperturbed) input data array.

The comparison of the output for a layer of the neural network processing when processing the perturbed version of the input data array to the stored output of the processing of that layer when processing the (unperturbed) input data array may be carried out in any suitable and desired manner. In embodiments, the comparison is carried out by the same processor that performs the neural network processing. However, it would, instead, be possible for the comparison to be carried out by a separate processor to the processor that performs the neural network processing. For example, in some embodiments the neural network processing is performed by a neural network processing unit (NPU) or graphics processing unit (GPU), whereas the comparison is carried out by the CPU.

After comparing the output for the layer of the neural network processing generated when processing the perturbed version of the input data array to the stored output for the processing for that layer when processing the original (unperturbed) data array, a determination is made as to whether (or not) to continue the neural network processing for a part or parts of the perturbed version of the input data array, based on the comparison. This determination can be carried out in any suitable or desired manner.

In some embodiments, it is (only) determined to (fully) terminate the neural network processing of the perturbed version of the input data array when the two outputs are deemed to match (or be sufficiently similar) in their entirety, as this should mean that the final output result that would be generated when (completely) processing the perturbed version of the input data array would be the same as the final output result generated when processing the (unperturbed) input data array (and, thus, it can be reasonably determined that the perturbation that was made to the input data array does not affect the final output result).

For example, in embodiments wherein the outputs that are compared comprise data values of the data elements of the respective generated output data arrays, and the outputs are compared on a data element-by-data element basis, the system may operate to require an exact match of (e.g. all of) the data values of the corresponding data elements for the two corresponding outputs, in order to (fully) terminate the neural network processing of the perturbed version of the input data array

However, it would also be possible, in these embodiments, to instead only require that corresponding data values for corresponding data elements in the two outputs to be sufficiently similar to each other, for there to be a determination to (fully) terminate the neural network processing of the perturbed version of the input data array (e.g. to allow a small amount of divergence between the two outputs).

Additionally or alternatively, in the case where data element-by-data element comparisons are carried out for a plurality of data positions, in embodiments it is only determined to (fully) terminate the neural network processing of the perturbed version of the input data array if the data values for all of the corresponding pairs of data pairs from the two outputs (that are being compared) match each other.

However, it would also be possible to allow, for example, in an embodiment no more than a threshold number of data values to not match, for it still to be determined that the rendered portion of the second version of the frame (sufficiently) matches the corresponding portion of the first version of the frame.

Similarly, in embodiments wherein the comparison process (instead) comprises comparing information representative of the output data array that is generated by the layer(s) when processing the perturbed input data array to (stored) information representative of the output data array that is generated by the layer(s) when processing the (unperturbed) input data array, the comparison may require an exact match of that information for it to correspondingly be determined to (fully) terminate the neural network processing of the perturbed version of the input data array, or it may require only that the information representative of the content, e.g. signatures, are sufficiently similar to each other.

In some embodiments, it is determined to continue neural network processing for (part or parts of) the perturbed version of the perturbed version of the input data array, when the two outputs are deemed not to match (or be sufficiently similar) in their entirety. As will be understood, the continuing neural network processing will comprise processing the next (and, e.g. further) layer(s) of the neural network (in respect of the perturbed version of the input data array).

In some embodiments, it may be determined from the comparison of the two outputs that some, but not all, of the two outputs match. For example, the system may determine that (only) a part of one output (corresponding to a portion of a generated output array) matches (or is sufficiently similar to) a corresponding part of the other output (corresponding to a corresponding portion of the other generated output array).

For example, in embodiments wherein the outputs that are generated comprise data values of the data elements of the respective generated output data arrays, and the outputs are compared on a data element-by-data element basis, a partial match such as this may occur if the data values of a certain number of pairs of data elements that correspond to a corresponding portion of the two generated output array match (but the data values of other data elements do not).

In embodiments wherein the outputs comprise information representative of the content of the respective generated output data arrays, a partial match may occur when respective subsets of the information representative of the content of the respective generated output data arrays (which correspond to a particular portion of the respective generated output data arrays) are determined to match (but other respective subsets, corresponding to other particular portions of the respective generated output data arrays, do not).

In some of these embodiments, when a partial match such as this occurs, neural network processing is terminated in respect of the part of the output (output data array) for the layer generated when processing the perturbed version of the input data array for which a match was determined to have occurred, but continue neural network processing in respect of the remaining part of the output (output data array). In other words, when the system determines that a only part of the two outputs match (in the manner described above), rather than terminate neural network processing for the perturbed input data array entirely, or continue neural network processing for the perturbed input data array based on the (entirety) of the output (output data array) that was generated, neural network processing is continued for the perturbed version of the input data array, but only using the part of the generated output (output data array) which was determined not to match (e.g. by forwarding only that part of the generated output (output data array) to the next layer of the neural network).

The Applicants have recognised in this regard that by making use of this determination of a partial match, and terminating part of the neural network processing of the perturbed version of the input data array accordingly, the system can reduce the overall processing burden when performing neural network of the (whilst still performing processing that is sufficient to determine whether or not the perturbation of the input data array gas an effect on the result of the neural network processing).

Hence, in another embodiment of the technology described herein, the method comprises (and the processor is correspondingly configured to) when it is determined that only a part of the output for the layer of the neural network processing when processing the perturbed version of the input array does not match the stored result for the corresponding part of the output for that layer when processing the (unperturbed) input data array, continuing processing for the perturbed version of the data array for only that (non-matching) part of the output for the layer of the neural network processing when processing the perturbed version of the input array.

In some embodiments, neural network processing is performed on a block-by-block basis. In other words, an input data array that is to be subjected to neural network processing (such as the original (unperturbed) version of the input data array) is divided into one or more, and in an embodiment a plurality of, blocks, with each block then being processed through a sequence of operations (layers) that make up (at least a portion of) the neural network (e.g. independently of any other block). Each block that the input data array is divided into in an embodiment comprises an appropriate, in an embodiment contiguous, set of the data elements of the input data array.

The individual blocks that the input data array is divided into can have any suitable and desired size and configuration (in terms of the number and configuration of the data elements for the block). Each block in an embodiment has the same size and configuration as the other blocks that the input data array is divided into.

In some of these embodiments, when performing neural network processing for the perturbed version of the input data array, only some (but not all) of the perturbed version of the input data array is subjected to neural network processing by only performing neural network processing for the block or blocks of only a portion of the input data array which contain(s) the perturbed part of the input data array. Therefore, rather than perform neural network processing for each and every block that would make up the entirety of the perturbed version of the input data array, neural network processing is only performed in respect of a subset of those blocks.

The Applicants have recognised in this regard that is possible to reduce the number of blocks that will need to be processed when performing the neural network processing for the perturbed version of the input data array by choosing a location and size of region that is perturbed to reduce the total number of blocks which the perturbation covers. For example, rather than choosing to perturb an area of the input data array that spans a plurality of blocks that the perturbed input data array would be divided into, it may be possible to instead choose to perturb an area that spans fewer (e.g. only a single) block.

The Applicants have recognised that this can be facilitated by choosing to perturb a region of the input data array such that the perturbed region is (at least partially) aligned with boundaries of the blocks that the input data array is divided into, i.e. matching the boundaries of the perturbed region to the boundaries of the blocks, such that the perturbed region does not straddle (at least some) of the boundaries between blocks (and such that the perturbed region comprises an integer number of whole (complete) blocks only). Choosing the perturbed region to reduce the number of blocks that are processed in this manner may save processing power expended and reduce the total time taken to perform the neural network processing using the perturbed version of the input data array.

Thus, according to embodiments of the technology described herein, neural network processing for the input data array is performed on a block-by-block basis, such that the input data array is divided into and processed as one or more blocks, and the perturbation is applied to a region of the input data array; wherein the perturbed region is confined to a single block of said one or more blocks or comprises an integer number of whole blocks; and/or at least one boundary of the perturbed region aligns with at least one boundary between said one or more blocks.

The Applicants have also recognised that it may be possible (in these and other embodiments of the technology described herein) to reduce the processing power expended and/or the total time taken to perform neural network processing using the perturbed version of the input data array by matching the size of the perturbed region to other processing characteristics or limitations of the data processing system. For example, in some embodiments, the perturbed region size may be chosen to match a memory access transaction size of the data processing system, i.e. such that the entire perturbed region of the input data array can be sent as a single memory transaction and/or a plurality of “complete” memory transactions, e.g. when processing the perturbed version of the input data array. In some (e.g. other) embodiments, the perturbed region size may be chosen to match another characteristic of the data processing system, e.g. a particular cache size of the memory being used for storing data relating to the neural network processing being performed by the processor.

Thus according to another embodiment of the technology described herein, the perturbation is applied to a region of the input data array, wherein the size of the perturbed region is chosen based on a memory transaction size of the data processing system.

As discussed above, in the technology described herein, a perturbation is applied to some (but not all) of an input data array to generate a perturbed version of the input data array, and neural network processing is then performed using that perturbed version of the input data array (to determine whether the perturbation of the input data array has an effect on the result of the neural network processing). In some embodiments of the technology described herein, this process may be carried out for plural differently perturbed versions of the input data array (in addition to the first perturbed version of the input data array). Thus, in some embodiments, a (different) perturbation may be applied to a part (but not all) of the (original) input data array, to generate a further (different) perturbed version of the input data array, with neural network processing being performed for that further perturbed version of the input data array (to determine whether that (different) perturbation of the input data array has an effect on the result of the neural network processing). This may be continued for further perturbations of the input data array, e.g. as desired.

In these embodiments, the perturbations that are used to the plural differently-perturbed versions of the input data array may be of any suitable or desired form, e.g. as described above.

Each of the perturbations that are used to generate their own perturbed version of the input data array should be and in an embodiment is distinct from perturbation(s) used to generate the other perturbed versions of the input data array. For example, the type of perturbation operation used to generate a perturbed version of the input data array may be different to the type of perturbation operation used to generate another (differently) perturbed version of the input data array; and/or the perturbation may be applied to a different part of the original input data array to generate a perturbed version of the input data array compared to the part of the original input data array to which a perturbation is applied when generating another (differently) perturbed version of the input data array.

In some embodiments, each differently perturbed version of the input data array is perturbed in a different part of the input data array. For example, each differently perturbed version of the input data array may be perturbed in a different particular region of the input array (wherein those different regions of the input data array may or may not be the same size as one another and may or may not overlap with each other, as desired). In the case wherein the input data array comprises an image, each of the plural differently perturbed versions of the input data array could be perturbed in a different particular area (region) of the input data array. For example, a first perturbed version of the input data array could be perturbed in a (e.g. 4×4 or 8×8) group of pixels in the image, with a second perturbed version of the input data array being perturbed in a (e.g. 4×4 or 8×8) group of pixels that is adjacent to the first group of pixels, etc.

Neural network processing is in an embodiment performed for some of (and in an embodiment each of) the plural differently perturbed version of the input data array. When performing neural network processing for each of the plural differently perturbed versions of the input data array, in an embodiment only some but not all of the perturbed version of the input data array is subjected to neural network processing (in the manner described above), with the results of the neural network processing of each of the plural differently perturbed versions of the input data array in an embodiment then being compared to the result of the neural processing of the (unperturbed) input data array.

It would be possible to perform neural network processing for the plural differently perturbed versions of the input data array in any desired order. However, the Applicants have recognised that it may be beneficial to process the plural differently perturbed versions of the input array in an order that is based (at least in part) on the particular parts (e.g. regions) of the input data array of which have been perturbed in the different perturbed versions of the input data array, since this can lead to more efficient neural network processing of the set of differently-perturbed versions of the input data array.

For example, the order may be chosen such that different perturbed versions of the input data array that are perturbed in similar (e.g. adjacent, or overlapping) regions may be processed at a similar time. The Applicants have recognised that perturbed input arrays that are perturbed in similar regions may have parts of processing (e.g. calculations that are to be performed) in common. By choosing a processing order such that these similarly-perturbed input data arrays are processed at a similar time, the data processing system may advantageously re-use values calculated when performing neural network processing for one perturbed version of the input data array when performing neural network processing for another (similarly) perturbed version of the input data array.

The Applicants have also recognised that perturbed input arrays that are perturbed in similar regions may require the same data from memory (e.g. weight arrays, stored output values when processing the unperturbed input data array (as described above), etc.) for neural network processing to be performed. By choosing a processing order such that these similarly-perturbed input data arrays are processed at a similar time, the system may advantageously retrieve this data from memory (e.g. only a single time) and then use that data when performing neural network processing for each of the similarly-perturbed input data arrays (thereby reducing the amount of times this data needs to be retrieved from the memory).

Thus, in an embodiment of the technology described herein, the method further comprises (and the data processing system is further configured to) generating a set of plural differently perturbed versions of the input data array, each different perturbed version of the input data array being perturbed in a different part of the input data array;
subjecting each so perturbed version of the input data array to the neural network processing, wherein performing the neural network processing for a perturbed version of the input data array comprises subjecting only some but not all of the perturbed version of the input data array to neural network processing based on the part of the input data array to which the perturbation has been applied; and
selecting the order in which the different perturbed versions of the input data array are processed based on the parts of input data array that have been perturbed in the different perturbed versions of the input data array and an expected processing order for the neural network processing.

In some embodiments, neural network processing is performed in its entirety for a particular perturbed version of the input data array before moving onto performing neural networking for another perturbed version of the input data array.

However, in some embodiments, neural network processing of differently-perturbed versions of the input data array may overlap. For example, neural network processing for a particular layer of the neural network may be performed for a first perturbed version of the input data array, with neural network processing of that layer then being performed for one or more differently perturbed versions of the input data array, before neural network processing for the next layer of the neural network is then performed for the first perturbed version of the input data array, with neural network processing of that next layer then being performed for the one or more differently perturbed versions of the input data array etc. and so on. The Applicants have recognised that overlapping neural network processing of differently perturbed versions of the input data array in this manner may better facilitate the sharing of common calculated values and data (as described above) when performing neural network processing for the differently-perturbed versions of the input data array.

In some embodiments of the technology described herein, as discussed above, an output for a layer or layers of neural network processing of the (original unperturbed) input data array may be stored (in memory) and then retrieved at a time when neural network processing is to be performed for a perturbed version of the input data array (with the retrieved output then being re-used as part of the input when processing the next layer of the neural network when performing neural network processing for the perturbed version of the input data array). In these embodiments, when neural network processing is to be performed for a set of differently perturbed versions of the input data array (as discussed above), this stored output may be retrieved and then re-used when performing neural network processing for multiple of those differently perturbed versions of the input data array.

Thus, in an embodiment of the technology described herein, the method further comprises (and the data processing system is further configured to) storing the output of the neural network processing for a layer or layers of the neural network processing when processing the input data array in memory;
retrieving the stored output from memory;
reusing the retrieved output of the neural network processing for the layer or layers of the neural network processing stored from the processing of the initial input data array when performing the neural network processing for a first perturbed version of the input data array of the set of plural differently-perturbed versions of the input data array; and
reusing the retrieved output again when performing neural network processing for a second perturbed version of the input of the set of plural differently-perturbed versions of the input data array.

As well as the processor and the main memory, the data processing system of the technology described herein may include any other suitable and desired components, elements, etc., that a data processing system may comprise. Thus it may, for example, and in an embodiment does, comprise a host processor (e.g. CPU) that can execute applications that may require neural network processing by the processor that executes the neural network. The host processor (e.g. CPU), may, as discussed above, execute an appropriate driver for the neural network processor, to control the neural network processor to perform desired neural network processing operations. The data processing system may also include other processors (which may equally be able to perform neural network processing), such as a graphics processor, a video processor, an image signal processor (ISP), etc.

The data processing system may comprise and/or be in communication with one or more memories (such as the memories described above) that store the data described herein, and/or store software for performing the processes described herein. The data processing system may comprise and/or be in communication with a host microprocessor, and/or with a display for displaying output data associated with the neural network processing.

The data processing system of the technology described herein may be implemented as part of any suitable system, such as a suitably configured micro-processor based system. In some embodiments, the technology described herein is implemented in a computer and/or micro-processor based system.

The various functions of the technology described herein may be carried out in any desired and suitable manner. For example, the functions of the technology described herein may be implemented in hardware or software, as desired. Thus, for example, the various functional elements of the technology described herein may comprise a suitable processor or processors, controller or controllers, functional units, circuits, processing logic, microprocessor arrangements, etc., that are operable to perform the various functions, etc., such as appropriately dedicated hardware elements (processing circuits) and/or programmable hardware elements (processing circuits) that can be programmed to operate in the desired manner.

It should also be noted here that, as will be appreciated by those skilled in the art, the various functions, etc., of the technology described herein may be duplicated and/or carried out in parallel on a given processor. Equally, the various processing circuits may share processing circuits, etc., if desired.

It will also be appreciated by those skilled in the art that all of the described embodiments of the technology described herein may include, as appropriate, any one or more or all of the features described herein.

The methods in accordance with the technology described herein may be implemented at least partially using software e.g. computer programs. It will thus be seen that when viewed from further embodiments the technology described herein comprises computer software specifically adapted to carry out the methods herein described when installed on data processor, a computer program element comprising computer software code portions for performing the methods herein described when the program element is run on data processor, and a computer program comprising code adapted to perform all the steps of a method or of the methods herein described when the program is run on a data processing system.

The technology described herein also extends to a computer software carrier comprising such software which when used to operate a data processing system causes in a processor, or system to carry out the steps of the methods of the technology described herein. Such a computer software carrier could be a physical storage medium such as a ROM chip, CD ROM, RAM, flash memory, or disk, or could be a signal such as an electronic signal over wires, an optical signal or a radio signal such as to a satellite or the like.

It will further be appreciated that not all steps of the methods of the technology described herein need be carried out by computer software and thus from a further broad embodiment the technology described herein comprises computer software and such software installed on a computer software carrier for carrying out at least one of the steps of the methods set out herein.

The technology described herein may accordingly suitably be embodied as a computer program product for use with a computer system. Such an implementation may comprise a series of computer readable instructions fixed on a tangible, non-transitory medium, such as a computer readable medium, for example, diskette, CD ROM, ROM, RAM, flash memory, or hard disk. It could also comprise a series of computer readable instructions transmittable to a computer system, via a modem or other interface device, over either a tangible medium, including but not limited to optical or analogue communications lines, or intangibly using wireless techniques, including but not limited to microwave, infrared or other transmission techniques. The series of computer readable instructions embodies all or part of the functionality previously described herein.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable medium with accompanying printed or electronic documentation, for example, shrink wrapped software, pre-loaded with a computer system, for example, on a system ROM or fixed disk, or distributed from a server or electronic bulletin board over a network, for example, the Internet or World Wide Web.

A number of embodiments of the technology described herein will now be described.

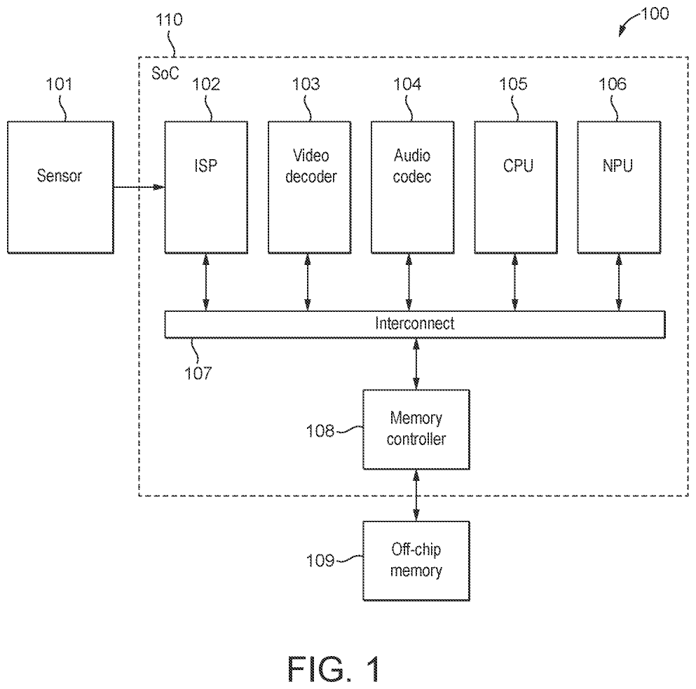

FIG. 1 shows schematically a data processing system 100 in which the present embodiments may be implemented. The system 100 comprises a System on Chip (SoC) system 110. Part of the data processing system which may be on chip comprise an image signal processor (ISP) 102, a video decoder 103, an audio codec 104, a CPU 105 and a neural network processor (NPU) 106, which may be operably connected to a memory controller 108 by means of a suitable interconnect 107. The memory controller 108 may have access to external, off-chip memory 109. A sensor 101 may provide input data for the system 100 (e.g. video data and/or sound data from a suitable camera or microphone or other sensor device). Although the CPU and NPU are shown separately in FIG. 1, the neural network could be executed by the CPU or GPU, if desired.

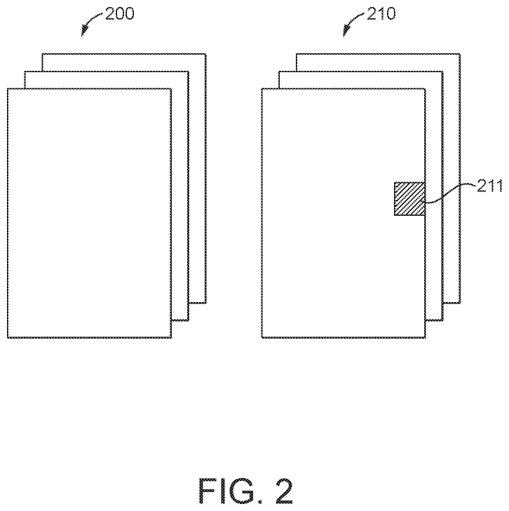

FIG. 2 shows an input data array 200 and a perturbed version 210 of the input data array. In the present embodiment, the input data array 200 comprises a three channel RGB image. However, the input data array could be any suitable type of data array (e.g. sound data).

As can be seen in FIG. 2, the perturbed version of the input data array 210 differs for the original (unperturbed) input data array 200 in that a part (but not all) of the input data array has been perturbed. Any suitable perturbation may be used. In the embodiment shown in FIG. 2, a group of pixels 211 have been “zeroed” (i.e. their pixel values have been set to zero) in one of the channels.

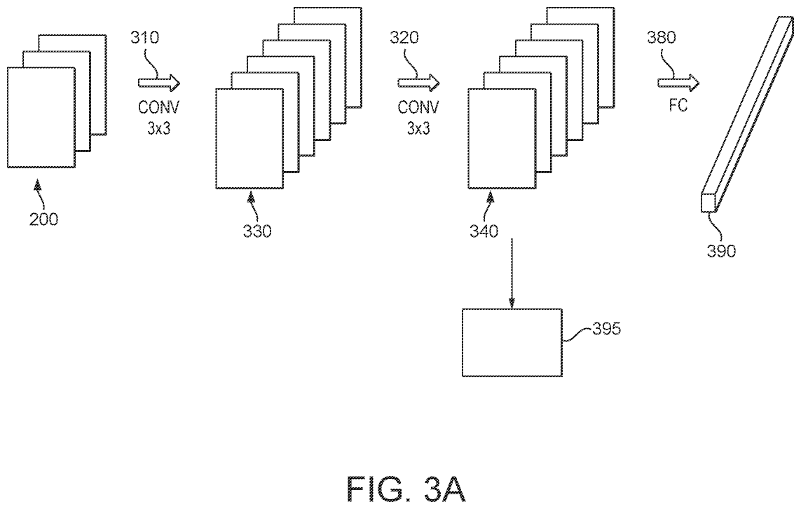

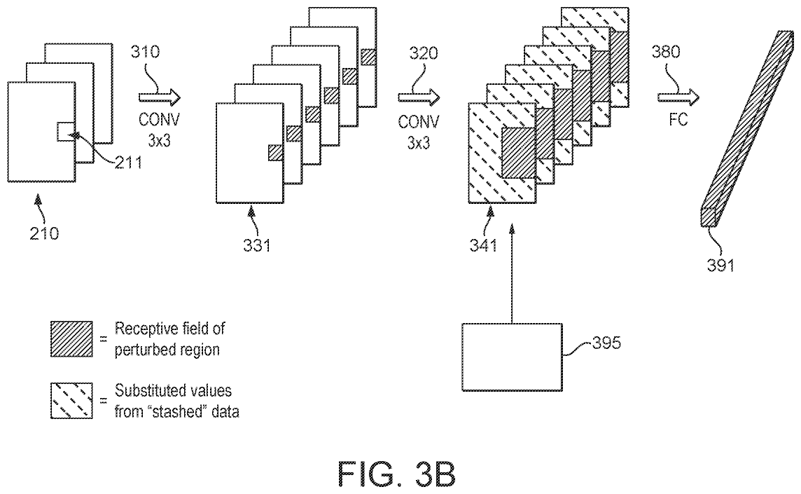

FIG. 3A shows schematically the neural network processing of the unperturbed version of the input data array 200. The neural network may be any suitable type of neural network. In the present embodiments, the neural network is a convolutional neural network (CNN). As will be understood, the CNN comprises a number of layers which operate one after the other, such that the output from one layer is used as the input for a next layer. The CNN of FIG. 3A comprises two convolutional layers (310, 320) followed by a single fully connected layer 380, which outputs a final result 390.

Although FIG. 3A shows a certain number of convolutional and FC layers, the neural network may comprise fewer or more such layers if desired (and may or also or instead comprise other layers which operate in a different manner). For example, the neural network may also or instead comprise one or more pooling layers.

In the embodiment shown in FIG. 3A, the (entire) (unperturbed) input data array 200 is received as an input to the first convolutional layer 310. The convolutional layer operates on the input data array 200 to provide an output data array 330 (comprising a set of “feature maps”), which is passed onto the next convolutional layer 320 (as an input for that layer). This next convolutional layer 320 operates on the data array 330 output by the previous layer 310 to provide an output data array 340.

The data array 340 output by the convolutional layer 320 is stored (“stashed”) to memory 395. As will be discussed below, this allows this output for the convolutional layer 320 to be re-used when performing neural network processing for the perturbed version of the input data array (discussed in further detail below in relation to FIG. 3B).

In the neural network processing of the unperturbed version of the input array 200 shown in FIG. 3A, the data array 340 is used as an input to the fully connected layer 390. The fully connected layer 390 operates on the data array 340 to provide a final output result 390 of the neural network processing of the (unperturbed) input data array 200. The final output result 390 may be passed towards other components of the data processing system which are outside the neural network (e.g. such as further processing and display components which can display the final output result), for example. In an embodiment, the final output result 390 is stored to memory, so that it can be compared to the corresponding final output result of the neural network processing of the perturbed version of the input data array (discussed in further detail below in relation to FIG. 3B).

FIG. 3B shows schematically the neural network processing of a perturbed version of the input data array 210, using the same neural network as shown in FIG. 3A. As discussed above, the perturbed version of the input data array 210 differs from the unperturbed input data array 200 in that it comprises a region of pixels 211 that have been perturbed.

When performing neural network processing for the perturbed version of the input data array 210, rather than subject the entire data array to neural network processing (as was the case when processing the unperturbed input data array 200 as shown in FIG. 3A, for example), only the perturbed portion 211 of the perturbed version of the input data array 210 is subjected to neural network processing. Thus, rather than have the first convolutional layer 310 operate on the entire perturbed version of the input data array 210 (as it did when processing the unperturbed input data array 200), the first convolutional layer 310 instead only operates on the perturbed portion 211 of the perturbed version of the input data array 210.

(Although in the embodiment shown in FIG. 3B, the part of the perturbed version of the input data array that is subjected to neural network processing directly corresponds to the perturbed region 211, this need not necessarily be the case. For example, the part of the input data array that is subjected to neural network processing could be a region (larger than the perturbed region 211) that encompasses the perturbed region 211 as well as another (unperturbed) region of the perturbed input data array 210.)

The first convolutional layer 310 operates on the perturbed portion 211 (only) of the perturbed version of the input data array 210, thereby generating a partial output data array 331. As shown schematically in FIG. 3B, since the first convolutional layer 310 processes only a part of the perturbed version of the input data array, the partial output data array 331 for the first convolutional layer 310 comprises only a part of a (full) output data array (such as the output data array 310 shown in FIG. 3A). This (partial) output data array 311 may be considered to be in the “receptive field” of the perturbed region 211 of the perturbed version of the input data array 210. (As shown in FIG. 3B, the receptive field of the perturbed region 211 will also encompass the partial output generated by the next layer, as well as the final output of the fully connected layer (discussed further below)).

Partial output data array 331 generated by convolutional layer 310 is then passed onto the next convolutional layer 320, which operates on the partial data array 341 to generate another partial output data array 341.

Unlike the convolutional layers 310 and 320, fully connected layer 380 may not be able to generate a meaningful output on the basis of only a partial input data array. Therefore fully connected layer 380 may not be able generate a meaningful output based on the partial data array 341 (that has been output by the convolutional layer 320) alone.

In order to process the fully connected layer 380, the “stashed” (stored) output 340 (that was generated by the convolutional layer 320 when performing neural network processing for the unperturbed version of the input data array) is retrieved from memory 395, and re-used. In particular, “missing” values in the partial data array 341 are substituted with their corresponding values from the output 340 (as shown schematically in FIG. 3B), thereby providing a “full” data array to be processed by the fully connected layer 380. The fully connected layer operates on this data array (which is made up of the partial data array 341 generated by the convolutional layer 341 and the substituted values from the output 340) in order to generate a final output result 391 of the neural network processing of the perturbed version of the input data array 210.

This final output result 391 is then compared to the final output result 390 that was generated when performing neural network processing for the unperturbed input data array 200. If the two final output results are determined to match (or to be sufficiently similar), then it may be reasonably assumed on the basis of the comparison that the perturbation does not have a (meaningful) effect on the result of the neural network processing. If, on the other hand, the two final output results are determined not to match (or not to be sufficiently similar) then it may be reasonably assumed that the perturbation does have an effect on the result of the neural network processing.

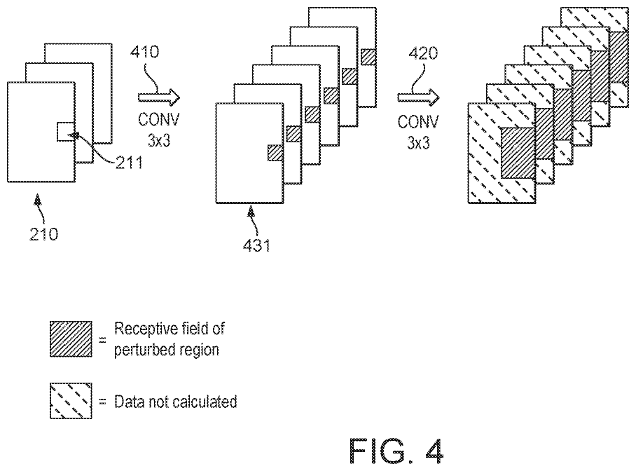

FIG. 4 shows neural network processing of a perturbed version of an input data array in another embodiment of the technology described herein. In this embodiment, the neural network is a CNN, but differs from the CNN shown in FIGS. 3A and 3B in that it does not comprise a fully connected layer, but rather comprises two convolutional layers 410 and 420 only. Since the CNN of FIG. 4 comprises only convolutional layers (and no fully connected layer), it is possible for the CNN to generate a meaningful output based only on the neural network processing of the part of the perturbed version of the input data array, without requiring, e.g., a “stashed” (stored) output for a layer of the neural network processing when processing the (unperturbed) input data array (as was required in the embodiment shown in FIGS. 3A and 3B, for example).

In the embodiment shown in FIG. 4, the first convolutional layer 410 operates on the perturbed portion 211 (only) of the perturbed version of the input data array 210, thereby generating a partial output data array 431. The partial output data array 431 is then passed onto the next convolutional layer 420, which operates on the partial data array 431 to generate a final output result 441.

As shown schematically in the FIG. 4, this final output result 441 comprises a partial data array, which may then be compared to corresponding portions of an output result of the neural network processing of the (unperturbed) input data array. If the final output result (partial data array) 341 is determined to match (or to be sufficiently similar to) the corresponding portions of the output result of the neural network processing of the (unperturbed) data array, then it may be reasonably assumed on the basis of the comparison that the perturbation does not have a (meaningful) effect on the result of the neural network processing.

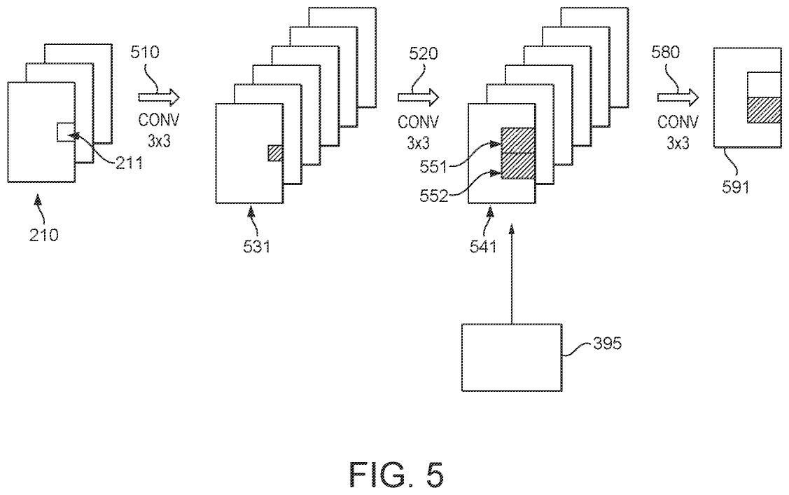

FIG. 5 shows neural networking processing of a perturbed version of an input data array according to another embodiment of the technology described herein. In this embodiment, the neural network is a CNN comprising three convolutional layers 510, 520 and 580.

In this embodiment (and similarly to the embodiments discussed above), the first convolutional layer 510 operates on the perturbed portion 211 (only) of the perturbed version of the input data array 210, thereby generating a partial output data array 531, which is then passed onto the next convolutional layer 420, which operates on the partial data array 531 to generate a partial output data array 541.

At this stage, the output of processing convolutional layer 520 when processing the unperturbed input data array, which has been stored in memory 395 (in a similar manner to as described above in relation to the embodiment shown in FIG. 3A) is retrieved from the memory 395. However, in this embodiment, rather than re-use the values from the stored output to process the next layer (as was the case in the embodiment shown in FIG. 3B, for example), values in the partial output data array 541 are compared to their corresponding values in the stored output (that were calculated when processing the unperturbed input data array).

If the entire partial output data array 541 is determined to match (or to be sufficiently similar) to the corresponding part of the output that was stored when processing the unperturbed input data array, then it may be reasonably assumed on the basis of the comparison that the perturbation does not have a (meaningful) effect on the result of the neural network processing, and neural network processing may be terminated at this point.

If the entire partial output data array 541 is determined to not match (or not to be sufficiently similar) to the corresponding part of the output that was stored when processing the unperturbed input data array, then neural network processing may be continued in respect of the entire partial output data array.

However, FIG. 5 illustrates a case where a first portion 551 of the partial output data array 541 is determined to match (or be sufficiently similar to) the corresponding portion of the stored output, but a second portion 552 is determined not to match (or be sufficiently similar to) its corresponding portion of the stored output. In this case, rather than terminate the neural network processing entirely for the perturbed version of the input data array, or proceed to continue neural network processing for the entire partial output data array 541 by the next layer 580, neural network processing is continued for the second portion 552 of the partial output data array 541 only. Thus the second portion 552 (only) of the partial output data array is passed onto the next convolutional layer 580, which operates on the second portion 552 to generate a final output result 591.

This final output result 591 comprises a partial data array, which may then be compared to corresponding portions of the output result (not shown) of the neural network processing of the (unperturbed) input data array (in a similar manner to as described above in relation to FIG. 4, for example).

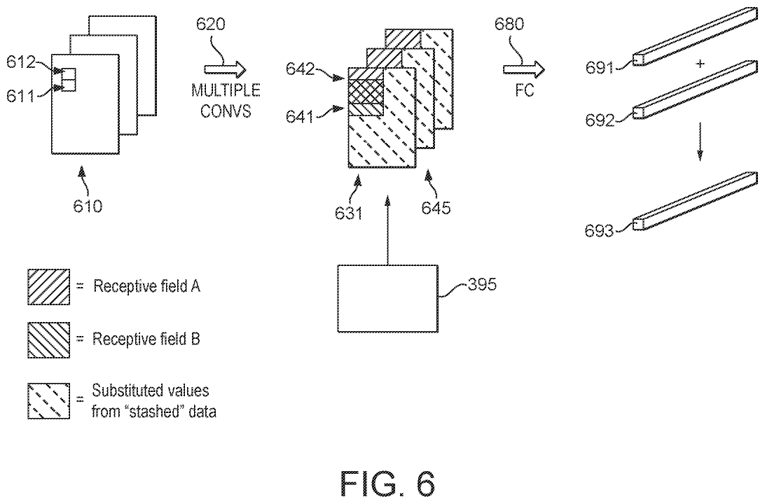

FIG. 6 shows schematically the neural network processing of two similarly-perturbed versions of an input data array in another embodiment of the technology described herein. In this embodiment, the neural network is a CNN comprising multiple convolutional layers 620 and a fully connected layer 680.

In this embodiment, two differently perturbed versions of the input data array 610 are generated. The first perturbed version of the input data array differs from the original (unperturbed) input data array in that it comprises a perturbed region 611 (perturbation A). The second perturbed version of the input data array differs from the original (unperturbed) input data array in that it comprises a (different) perturbed region 612 (perturbation B). The two perturbed versions of the input data array may be considered to be similarly perturbed in that the perturbed regions 611 and 612 are adjacent to one another.

Each of the two perturbed versions of the input data array are subjected to neural network processing. Similarly to the embodiments described above, rather than subject the entirety of the two perturbed versions to neural network processing, only the perturbed portions 611 and 612 are subjected to neural network processing. Thus, when subjecting the first perturbed version to neural network processing, the first convolutional layer operates on only the perturbed region 611, to generate a partial output data array, which is then operated on by the next convolutional layer, etc., e.g. in the manner discussed above. Similarly, when subjecting the second perturbed version to neural network processing, the first convolutional layer operates on only the perturbed region 612, to generate a partial output data array, which is then operated on by the next convolutional layer, etc.

In this embodiment, neural network processing for the two perturbed versions of the input data array is interleaved. Thus, rather than perform neural network processing for the first perturbed version of the input data array in its entirety before beginning performing neural network processing for second perturbed version of the input data array, neural network processing is performed for the first convolutional layer for the first perturbed version of the input data array, and then neural network processing is performed for the first convolutional layer for the second perturbed version of the input data array, before neural network processing for the second layer is performed for the first perturbed version of the input data array, and then neural network processing for the second layer is performed for the second perturbed version of the input data array, etc. (and so on).

Through performing processing through the multiple convolutional layers 620, a partial output array is generated for each of the two perturbed versions of the input data array; a first partial output data array 641 is generated in respect of the perturbed region 611 (i.e. the first perturbed version of the input data array), and a second partial output data array 642 is generated in respect of perturbed region 612 (i.e. the second perturbed version of the input data array). As shown in FIG. 6, the two partial output data arrays (and thus the “receptive fields” of the two perturbed regions 611 and 612) overlap with one another.

Similarly to as described above in relation to the embodiment shown in FIG. 3B, fully connected layer 680 may not be able to generate a meaningful output based on either of the partial output data arrays 641 or 642 alone. Thus, the “stashed” (stored) output (that was generated when performing neural network processing for the unperturbed version of the input data array) is retrieved from memory 395, so that it may be re-used to process the fully connected layer 680 in respect of both of the partial output data arrays 641 and 642.

In this embodiment, values from the “stashed” output corresponding to the “missing” portion of both of the partial output data arrays 641 and 642 are input as a partial data array 645 to the fully connected layer 680, thereby generating a partial result for the stashed data 691.

This partial result for the stashed data 691 may then be added to partial results generated by fully connected layer 680 for each of the partial data arrays 641 and 642, to generate a final output result of neural network processing for the first and second perturbed versions of the input data array.

Thus, and as shown in FIG. 6, partial output data array 641 is input into the fully connected layer 680 to generate a partial output result 692. This partial output result 692 is then added to the partial result calculated for the stashed data 691 to give a final (summed) output result for the first perturbed version of the input data array 693.

(FIG. 6 only shows the calculation of the final output result for the first perturbed version of the data array. However a final (summed) output result for the second perturbed version of the input data array may similarly be calculated by adding the partial result calculated for the stashed data 691 to a partial output data result generated when the fully connected layer 680 operates on the partial output data array 642.)

The final output results for the first and second perturbed versions of the input data array are then each compared to the final output result generated when performing neural networking for the original (unperturbed) version of the input data array (in a manner similar to as discussed above), to determine whether or not the first or second perturbations have a meaningful effect on the result of the neural network processing. If the final output result for the (first or second) perturbed version of the input data array is determined to match (or to be sufficiently similar) to the final output result generated when performing neural networking for the original (unperturbed) version of the input data array, then it may be reasonably assumed on the basis of the comparison that the (first or second) perturbation does not have a (meaningful) effect on the result of the neural network processing. If, on the other hand, they are determined not to match (or not to be sufficiently similar) then it may be reasonably assumed that the (first or second) perturbation does have an effect on the result of the neural network processing.

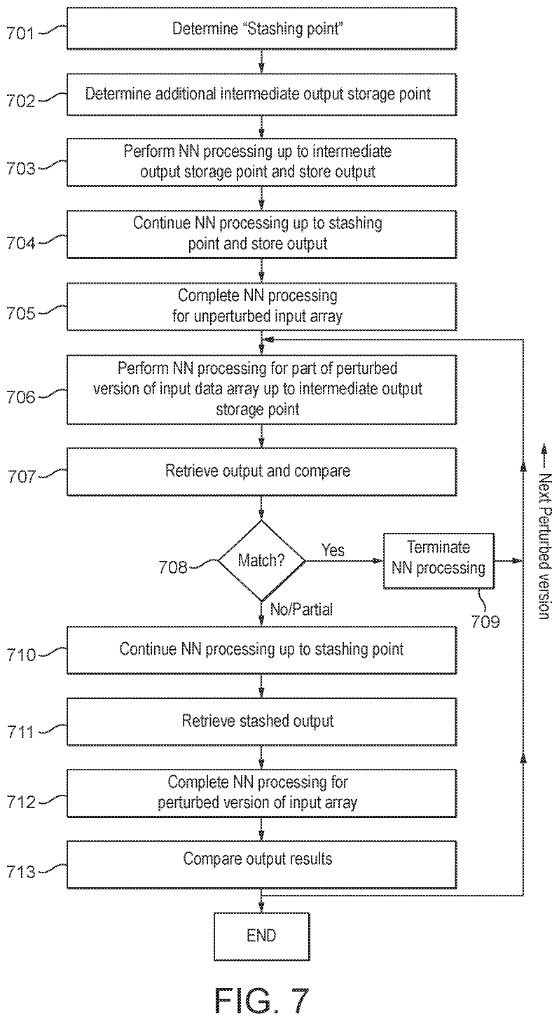

FIG. 7 shows a flow diagram of the neural network processing for an unperturbed input data array and a set of differently-perturbed versions of an input data array, according to an embodiment of the technology described herein.

In step 701, a “stashing point” of the neural network is determined, i.e. a position in the network wherein an output from a particular layer will be stored when processing the unperturbed version of the input data array, such that it may be retrieved and re-used when processing a perturbed version of the input data array. The particular layer for which an output is stored may be a layer in the neural network immediately preceding a fully connected layer (as in the embodiment shown in FIGS. 3A and 3B, for example). However, this need not necessarily be the case, and the particular layer for which an output is stored may be chosen as desired (e.g. based on the structure of the neural network and the size of the part of the perturbed version of the input data array that is to be processed).

In step 702, an additional intermediate output storage point is determined, i.e. a position in the network wherein an output from a particular layer will be stored when processing the unperturbed version of the input data array such that it can be retrieved and compared to an output from the same layer when processing the perturbed version of the input data array.

In step 703, neural network processing is performed for the unperturbed version of the input data array up until the intermediate output storage point, wherein the output of the particular layer is stored in memory.

In step 704, neural network processing is continued for the unperturbed version of the input data array up until the stashing point, wherein the output of the particular layer is stored in memory.

In step 705, neural network processing is completed for the unperturbed version of the input data array, thereby generating a final output result for the neural network processing of the unperturbed version of the input data array.

Steps 706-713 may be performed for each perturbed version of the input data array in the set of differently-perturbed versions of input data array.

In step 706, neural network processing is performed for a part of the perturbed version of the input data array, up until the intermediate output storage point in the neural network is reached, resulting in a partial output data array being generated.

In step 707, the output that was stored at the intermediate output storage point when processing the unperturbed version of the input data array in step 703 is retrieved and compared to the partial output data array generated in step 706 to determine whether there is a match (step 708).

If the entire partial output data array generated in step 706 is determined to match (or be sufficiently similar to) its corresponding portion of the retrieved output stored when processing the unperturbed version of the input data array in step 703, then it may be reasonably assumed on the basis of the comparison that the perturbation does not have a (meaningful) effect on the result of the neural network processing, and neural network processing for the perturbed version of the input data array is terminated at this point (step 709). Step 706 may then performed for the next perturbed version of the input data array in the set of differently-perturbed versions of the input data array.

If, on the other hand, the partial output data array generated in step 706 is determined not to (or only partially) match (or be sufficiently similar to) its corresponding portion of the retrieved output stored when processing the unperturbed version of the input data array in step 703, then neural network processing for the perturbed version of the input data array is continued, up until the stashing point (step 710), resulting in another partial output data array being generated.

In step 711, the “stashed” output that was stored when processing the unperturbed version of the input data array in step 704 is retrieved, and used to fill in “missing” values for the partial output data array generated in step 710.

In step 712, neural network processing is completed for the perturbed version of the input data array using the partial output data array generated in step 704 and the “missing” values substituted in in step 711, thereby generating a final output result for the neural network processing of the perturbed version of the input data array.

In step 713 the final output result for the for the neural network processing of the perturbed version of the input data array generated in step 706 is compared to the final output result for the neural network processing of the unperturbed version of the input data array generated in step 703, to determine whether the perturbation has an effect of the result of the neural network processing.

Steps 706-713 may then be repeated for the next perturbed version of the input data array (and so on, as desired).

Although in various embodiments described above, a single stashing point in the neural network is used (and thus, the output for processing a single layer is stored when processing the unperturbed input data array) this need not necessarily be the case. For example, multiple stashing points within a neural network could be used (i.e. with the outputs for processing of multiple layers within the neural network stored when processing the unperturbed input data array). Stored outputs for the different layers of the neural network could be re-used, e.g. when performing neural network processing for differently-perturbed versions of the input data array (e.g. versions of the input data array with differently-sized perturbed regions).

Similarly, multiple intermediate output storage points could be used (i.e. with the outputs for processing of multiple layers within the neural network stored when processing the unperturbed input data array, with those outputs then compared to corresponding outputs generated when processing those layers when performing neural network processing for the perturbed version of input data array).

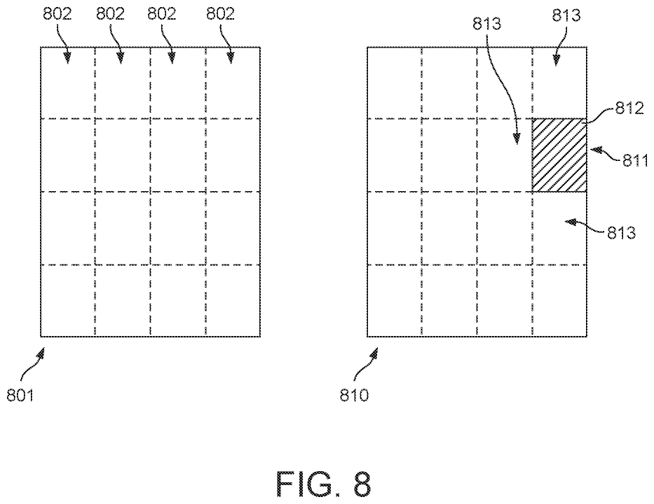

FIG. 8 shows an unperturbed input data array 801 and a perturbed version of the input data array 810 in an embodiment wherein neural network processing for the perturbed version of the input data array is performed on a block-by-block basis.

The unperturbed the input data array 801 is divided into a plurality of blocks 802. When performing neural network processing for the unperturbed version of the input array 801, each block that input data array is divided into is processed through the layers that make up (at least a portion of) the neural network, independently of the other blocks.

The perturbed version of the input data array 810 differs from the unperturbed input data array 801 in that a region 811 of the input data array has been perturbed. As shown in FIG. 8, the perturbed region 811 is confined to a single block 812 that the input data array is divided into, and the boundaries of the perturbed region align with the boundaries between the block 812 and the surrounding blocks 813. This means that when performing neural network processing for the perturbed version of the input array 801, only the block corresponding to the perturbed region 811 is subjected to neural network processing.

As will be appreciated from the above, the technology described herein, in its embodiments at least, can provide a more efficient way of performing perturbation-based neural network processing. This is achieved in the embodiments of the technology described herein at least, by subjecting only a part of a perturbed version of the input data array to neural network processing, based on the part of the input data array to which the perturbation has been applied. This then reduces the overall amount of processing that is required to be done for the perturbed version of the input data array, thereby providing an “explanation” for the operation of the neural network to a user at a reduced processing cost.

Whilst the foregoing detailed description has been presented for the purposes of illustration and description, it is not intended to be exhaustive or to limit the technology described herein to the precise form disclosed. Many modifications and variations are possible in the light of the above teaching. The described embodiments were chosen in order to best explain the principles of the technology described herein and its practical applications, to thereby enable others skilled in the art to best utilise the technology described herein, in various embodiments and with various modifications as are suited to the particular use contemplated. It is intended that the scope be defined by the claims appended hereto.

1. A method of performing neural network processing in a data processing system, the data processing system comprising a processor operable to execute a neural network, and operable to store data relating to the neural network processing being performed by the processor to memory, the method comprising:
for an input data array to be processed by a neural network, subjecting the input data array to neural network processing to generate a result of the neural network processing for the input data array; and
applying a perturbation to a part but not all of the input data array, and performing the neural network processing using the so-perturbed version of the input data array to generate a result of the neural network processing for the perturbed version of the input data array;
wherein
performing the neural network processing for the perturbed version of the input data array comprises:
subjecting only some but not all of the perturbed version of the input data array to neural network processing when performing the neural network processing for the perturbed version of the input data array, based on the part of the input data array to which the perturbation has been applied;
and
comparing the result of the neural network processing of the perturbed version of the input data array with the result of the neural network processing of the input data array without the perturbation, to determine whether the perturbation of the input data array has an effect on the result of the neural network processing.

2. The method of claim 1, comprising storing some or all of the output of the neural network processing for a layer or layers of the neural network processing when processing the input data array, and reusing the output of the neural network processing for the layer or layers of the neural network processing stored from the processing of the input data array when performing the neural network processing for the perturbed version of the input data array.

3. The method of claim 2, comprising reusing the output of the neural network processing for the layer or layers of the neural network processing stored from the processing of the input data array as part of an input for a fully connected layer or layers when performing neural network processing for the perturbed version of the input data array.

4. The method of claim 1, comprising:
storing the output of the neural network processing for a layer or layers of the neural network processing when processing the input data array;
comparing the output for a layer of the neural network processing when processing the perturbed version of the input data array to the stored result of the processing of that layer when processing the input data array; and
determining whether to continue the neural network processing for a part or parts of the perturbed version of the input data array on the basis of the comparison.

5. The method of claim 4, wherein the layer or layers for which the output is stored when the processing the input data array comprises a pooling layer, and the output for that pooling layer when processing the perturbed version of the input data array is compared to the stored result of the processing of that pooling layer when processing the input data array.

6. The method of claim 1, wherein neural network processing for the input data array is performed on a block-by-block basis, such that the input data array is divided into and processed as one or more blocks, and the perturbation is applied to a region of the input data array; such that:
the perturbed region is confined to a single block of said one or more blocks or comprises an integer number of whole blocks; and/or
at least one boundary of the perturbed region aligns with at least one boundary between said one or more blocks.

7. The method of any claim 1, wherein the perturbation is applied to a region of the input data array, and the size of the perturbed region is based on a memory transaction size of the data processing system.

8. The method of claim 1, comprising:
generating a set of plural differently perturbed versions of the input data array, each different perturbed version of the input data array being perturbed in a different part of the input data array; and
subjecting each so-perturbed version of the input data array to the neural network processing, wherein performing the neural network processing for a perturbed version of the input data array comprises subjecting only some but not all of the perturbed version of the input data array to neural network processing based on the part of the input data array to which the perturbation has been applied;
the method further comprising:
selecting the order in which the different perturbed versions of the input data array are processed based on the parts of input data array that have been perturbed in the different perturbed versions of the input data array and an expected processing order for the neural network processing.

9. The method of claim 8, further comprising:
storing the output of the neural network processing for a layer or layers of the neural network processing when processing the input data array in memory;
retrieving the stored output from memory;
reusing the retrieved output of the neural network processing for the layer or layers of the neural network processing stored from the processing of the initial input data array when performing the neural network processing for a first perturbed version of the input data array of the set of plural differently-perturbed versions of the input data array; and
reusing the retrieved output again when performing neural network processing for a second perturbed version of the input of the set of plural differently-perturbed versions of the input data array.

10. A method of performing neural network processing in a data processing system, the data processing system comprising a processor operable to execute a neural network, and operable to store data relating to the neural network processing being performed by the processor to memory, the method comprising:
for an input data array to be processed by a neural network, performing neural network processing using the input data array to generate a result of the neural network processing for the input data array, the performing neural network processing using the input data array comprising storing an output of the neural network processing for a layer or layers of the neural network processing when processing the input data array; and
applying a perturbation to a part but not all of the input data array, and performing neural network processing using the so-perturbed version of the input data array to generate a result of the neural network processing for the perturbed version of the input data array;
wherein performing the neural network processing for the perturbed version of the input data array comprises:
comparing an output for a layer of the neural network processing when processing the perturbed version of the input data array to the stored result of the processing of that layer when processing the input data array without the perturbation; and
determining whether to continue the neural network processing for a part or parts of the perturbed version of the input data array on the basis of the comparison.

11. A data processing system, the data processing system comprising:
a processor operable to execute a neural network and operable to store data relating to the neural network processing being performed by the processor to memory;
the data processing system further comprising a processing circuit configured to cause the processor to:
subject an input data array to neural network processing to generate a result of the neural network processing for the input data array;
and to
subject a perturbed version of the input data array to the neural network processing to generate a result of the neural network processing for the perturbed version of the input data array, the perturbed version of the input data array comprising a version of the input data array in which a perturbation has been applied to a part but not all of the input data array;
wherein
performing the neural network processing for the perturbed version of the input data array comprises:
subjecting only some but not all of the perturbed version of the input data array to neural network processing when performing the neural network processing for the perturbed version of the input data array, based on the part of the input data array to which the perturbation has been applied;
the data processing system further comprising:
a processing circuit configured to compare the result of the neural network processing of the perturbed version of the input data array with the result of the neural network processing of the input data array without the perturbation, to determine whether the perturbation of the input data array has an effect on the result of the neural network processing.

12. The system of claim 11, wherein the processing circuit is configured to store some or all of the output of the neural network processing for a layer or layers of the neural network processing when processing the input data array, and reuse the output of the neural network processing for the layer or layers of the neural network processing stored from the processing of the input data array when performing the neural network processing for the perturbed version of the input data array.

13. The system of claim 12, wherein the processing circuit is configured to reuse the output of the neural network processing for the layer or layers of the neural network processing stored from the processing of the input data array as part of an input for a fully connected layer or layers when performing neural network processing for the perturbed version of the input data array.

14. The system of claim 11, wherein the processing circuit is configured to:
store the output of the neural network processing for a layer or layers of the neural network processing when processing the input data array;
compare the output for a layer of the neural network processing when processing the perturbed version of the input data array to the stored result of the processing of that layer when processing the input data array; and
determine whether to continue the neural network processing for a part or parts of the perturbed version of the input data array on the basis of the comparison.

15. The system of claim 14, wherein the layer or layers for which the output is stored when the processing the input data array comprises a pooling layer, and the output for that pooling layer when processing the perturbed version of the input data array is compared to the stored result of the processing of that pooling layer when processing the input data array.

16. The system of claim 11, wherein the processing circuit is configured to cause neural network processing for the input data array to be performed on a block-by-block basis, such that the input data array is divided into and processed as one or more blocks, and the perturbation has been applied to a region of the input data array; such that:
the perturbed region is confined to a single block of said one or more blocks or comprises an integer number of whole blocks; and/or
at least one boundary of the perturbed region aligns with at least one boundary between said one or more blocks.

17. The system of claim 11, wherein the perturbation has been applied to a region of the input data array, and the size of the perturbed region is based on a memory transaction size of the data processing system.

18. The system of claim 11, wherein the processing circuit is configured to subject each perturbed version of the input data array of a set of plural differently perturbed versions of the input data array to the neural network processing, each different perturbed version of the input data array being perturbed in a different part of the input data array, wherein performing the neural network processing for a perturbed version of the input data array comprises subjecting only some but not all of the perturbed version of the input data array to neural network processing based on the part of the input data array to which the perturbation has been applied; and
the processing circuit is further configured to select the order in which the different perturbed versions of the input data array are processed based on the parts of input data array that have been perturbed in the different perturbed versions of the input data array and an expected processing order for the neural network processing.

19. The system of claim 18, wherein the processing circuit is configured to:
store the output of the neural network processing for a layer or layers of the neural network processing when processing the input data array in memory;
retrieve the stored output from memory;
reuse the retrieved output of the neural network processing for the layer or layers of the neural network processing stored from the processing of the initial input data array when performing the neural network processing for a first perturbed version of the input data array of the set of plural differently-perturbed versions of the input data array; and
reuse the retrieved output again when performing neural network processing for a second perturbed version of the input of the set of plural differently-perturbed versions of the input data array.

20. A non-transitory computer readable storage medium storing computer software code which when executing on at least one processor performs a method of performing neural network processing in a data processing system, the data processing system comprising a processor operable to execute a neural network, and operable to store data relating to the neural network processing being performed by the processor to memory, the method comprising:
for an input data array to be processed by a neural network, subjecting the input data array to neural network processing to generate a result of the neural network processing for the input data array; and
applying a perturbation to a part but not all of the input data array, and performing the neural network processing using the so-perturbed version of the input data array to generate a result of the neural network processing for the perturbed version of the input data array;
wherein
performing the neural network processing for the perturbed version of the input data array comprises:
subjecting only some but not all of the perturbed version of the input data array to neural network processing when performing the neural network processing for the perturbed version of the input data array, based on the part of the input data array to which the perturbation has been applied;
and
comparing the result of the neural network processing of the perturbed version of the input data array with the result of the neural network processing of the input data array without the perturbation, to determine whether the perturbation of the input data array has an effect on the result of the neural network processing.
